(19) United States
(12) Patent Application Publication
(10) Pub. No.: US 2026/0042092 A1
(43) Pub. Date: Feb. 12, 2026

(54) TRAY INSERT FOR USE IN SAMPLE ANALYSIS APPARATUS

(71) Applicant: Siemens Healthcare Diagnostics Inc., Tarrytown, NY (US)

(72) Inventors: Mohammed Arfan, Bangalore (IN); Sudipa Bhattacharya, Bangalore (IN); Vaishnav Ram Savarni K R, Bangalore (IN)

(73) Assignee: Siemens Healthcare Diagnostics Inc., Tarrytown, NY (US)

(21) Appl. No.: 19/101,483

(22) PCT Filed: Aug. 2, 2023
(86) PCT No.: PCT/US2023/071478

§ 371 Date: Feb. 5, 2025

Related U.S. Application Data
(60) Provisional application No. 63/370,707, filed on Aug. 8, 2022.

(51) Int. Cl. B01L 3/00

(52) U.S. Cl. CPC B01L 3/5023; B01L 2200/025; B01L 2200/16; B01L 2300/0825

(57) ABSTRACT

A tray insert for use with an apparatus configured to analyze a sample is disclosed. The tray insert includes a first surface comprising an elongated channel adapted to receive a reagent strip for sample analysis. Further, the insert includes a second surface, wherein the second surface is in a direction opposite to the first surface. Additionally, the insert includes a hollow enclosure between the first surface and the second surface, wherein the elongated channel on the first surface comprises a plurality of slots and wherein the slots comprise an opening on each end, wherein the opening enters the hollow enclosure.

### CROSS REFERENCE TO RELATED APPLICATIONS/INCORPORATION BY REFERENCE STATEMENT

This application claims benefit under 35 USC § 119(e) of U.S. Provisional Application No. 63/370,707, filed Aug. 8, 2022. The entire contents of the above-referenced patent application are hereby expressly incorporated herein by reference.

### FIELD OF TECHNOLOGY

The present disclosure relates to an apparatus for analysis of samples and more particularly to a tray insert to be used in the apparatus for analysis of samples.

### BACKGROUND

Urine analysis apparatus is a widely used portable point of care instrument. The apparatus uses dried-down biochemistry-based paper strip, known as a urine strip. The urine strip works on a colorimetric principle, wherein reagent pads on the urine strip change color corresponding to an analyte concentration present in a urine sample. Analysis of urine samples using a urine analysis apparatus requires urine strips to be dipped in urine sample for a short duration, removal of excess urine sample by blotting the urine strip with a blotting paper, and placement of the urine strip on a sample tray of the urine analysis apparatus for analysis. However, the step of removal of excess urine sample from the urine strip is not effective. A user may also miss this step altogether resulting in urine accumulation in the sample tray of the urine analysis apparatus. Frequent testing can cause accumulated urine to splatter on surfaces of test and analysis chamber, thereby compromising the sensitivity of testing process. Additionally, splattering of accumulated urine may also damage liquid sensitive optical and electronic components of the urine analysis apparatus. Furthermore, there is also a risk of sample contamination which interferes with subsequent urine analysis tests performed on the apparatus. Urine samples are also biohazardous and must be handled and disposed of carefully.

Therefore, there exists a need for an effective way of handling the urine samples that are analyzed by the urine analysis apparatus.

### SUMMARY

A tray insert for use in an analysis device is disclosed. In one aspect of the invention, the tray insert includes a first surface. The first surface has an elongated channel adapted to receive a reagent strip for sample analysis. The tray insert further include a second surface which is in a direction opposite to the first surface. Additionally, the tray insert includes a hollow enclosure between the first surface and the second surface. The elongated channel in the first surface includes a plurality of slots, wherein the slots comprise an opening on each end and the opening enters the hollow enclosure.

This summary is provided to introduce a selection of concepts in a simplified form that are further described below in the following description. It is not intended to identify features or essential features of the claimed subject matter. Furthermore, the claimed subject matter is not limited to implementations that solve any or all disadvantages noted in any part of this disclosure.

### BRIEF DESCRIPTION OF THE DRAWINGS

The present invention is further described hereinafter with reference to illustrated embodiments shown in the accompanying drawings, in which:

FIG. 1 illustrates a perspective view of a tray insert, according to an embodiment.

FIG. 2 illustrates an elongated channel on a first surface of the tray insert, according to an embodiment.

FIG. 3A illustrates a side view of the tray insert showcasing an opening, according to an embodiment.

FIG. 3B illustrates the tray insert attached to a suction inducing device, according to an embodiment.

FIG. 3C illustrates the tray insert attached to a suction inducing device, according to another embodiment.

FIG. 4 illustrates a perspective view of the tray insert being positioned in a support tray of an apparatus, according to an embodiment.

FIG. 5 illustrates a perspective view of the tray insert wherein the second surface of the tray insert is facing upwardly, according to an embodiment.

FIG. 6A illustrates a cross sectional view of the tray insert depicting a hollow enclosure, according to an embodiment.

FIG. 6B illustrates a side view of the tray insert depicting the hollow enclosure, according to an embodiment.

### DETAILED DESCRIPTION

Hereinafter, embodiments for carrying out the present invention are described in detail. The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure. Disclosed embodiments provide a tray insert for a sample analysis apparatus.

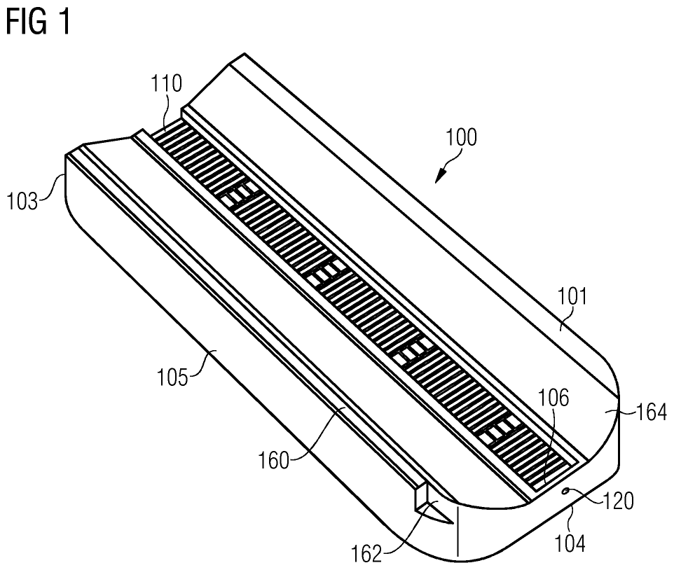

FIG. 1 illustrates a perspective view of a tray insert 100, according to an embodiment. The tray insert 100 includes a first surface 101 and a second surface (not shown in FIG. 1). The first surface 101 and the second surface face in opposite directions. The tray insert 100 further includes a first opposing end 103 and a second opposing end 104, connecting the first surface 101 and the second surface. The tray insert 100 also includes a first opposing side 105 and a second opposing side 106 connecting the first surface 101 and the second surface 102 and extending between the first opposing end 103 and the second opposing end 104. The first surface 101, the second surface, the first opposing end 103 and the second opposing end 104, the first opposing side 105 and the second opposing side 106 enclose a hollow enclosure.

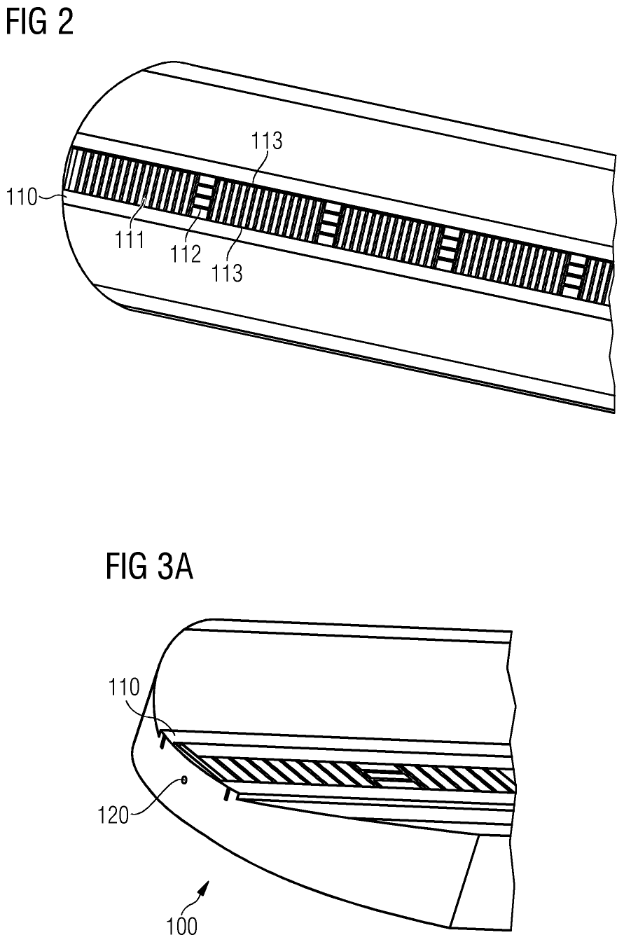

The first surface 101 of the tray insert 100 has an elongated channel 110 sized to accommodate a reagent strip. The reagent strip, for example, may have thin, non-reactive substrate on which a plurality of reagent pads is fixed. When each reagent pad comes in contact with a sample (for example, urine), the pad changes color over a period of time, depending on the reagent used and the characteristics of analyte present in the urine sample. In an embodiment, a top surface 107 of the second opposing end 104 is white such that an inspection/analysis apparatus can use the white end to determine if the reagent strip is correctly abutting the second opposing end 104 during an inspection/analysis procedure. Alternatively, the top surface 107 of the second opposing end 104 may be of any other suitable color. The elongated channel 110 comprises a plurality of slots, which is described further in FIG. 2.

The first and the second opposing ends 103, 104 of the tray insert 100 have different shapes to ensure that a user will correctly orient the tray insert 100 within a support tray during use. The shape of the first opposing end 103 of the tray insert 100 is rectangular and the shape of the second opposing end 104 of the tray insert 100 is curved. The tray insert 100 also includes an elongated guide 160 which enable smooth extension and retraction of tray insert from the support tray/apparatus. Further, the tray insert 100 includes sinks 162 in the elongated guide 160 that prevents excess liquid sample from flowing from the tray insert 100 down the elongated guide 160 (and thus into the apparatus). Therefore, the sinks 162 help in preventing contamination of the apparatus by excess liquid sample contained on the insert 100 or reagent strip. The first surface 101 of the tray insert 100 also includes a sloped surface 164 that may correspond to a sloped surface of the support tray when the tray insert 100 is positioned within the support tray. The sloped surface of the support tray aids in the proper optical machine inspection of the reagent strip.

FIG. 2 illustrates an elongated channel 110 on a first surface 101 of the tray insert 100, according to an embodiment. The elongated channel 110 comprises a plurality of slots 111, 112. A portion of the slots are horizontal 111, i.e., the slots run from the first opposing side 105 to the second opposing side 106. Another portion of the slots are vertical 112, i.e., the vertical slots 112, for example, connect one horizontal slot on one end and another horizontal slot on other end. In an embodiment, the horizontal slots 111 are more than the vertical slots 112. The horizontal slots 111 include an opening 113 on each end of the slot such that any liquid collected in the horizontal slot 111 enters the hollow enclosure from the openings 113. The horizontal slots 111 and the vertical slots 112 create a capillary action to propel the liquid towards the opening 113, thereby enabling the movement of the liquid into the hollow enclosure. The liquid may be, for example, excess urine sample dripped from the reagent strip placed on the elongated channel 110 of the tray insert 100. The vertical slots 112 enable easier movement of the liquid to the horizontal slots 111 and thereafter to the opening 113. This allows the elongated channel 110 to be free to excess liquid effectively.

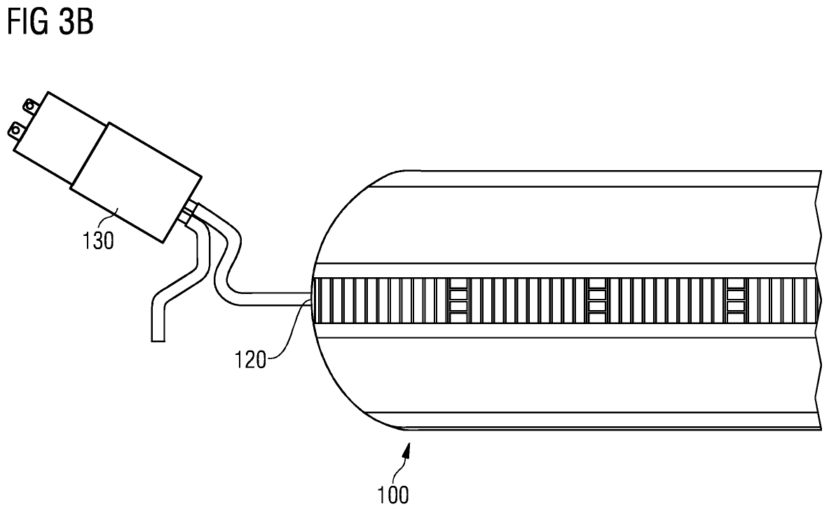

FIG. 3A illustrates a side view of the tray insert 100 showcasing an outlet 120, according to an embodiment of the invention. The outlet 120 is positioned on the second opposing end 104 of the tray insert 100 such that the outlet 120 acts as an outlet for the hollow enclosure. FIG. 3B illustrates the tray insert 100 attached to a suction inducing device 130, according to an embodiment. For example, the suction inducing device 130 is a vacuum pump. In an embodiment, the vacuum pump 130 may be motorized and self-priming such that it creates a vacuum pressure lower than atmospheric pressure such that the accumulated liquid in the hollow enclosure is sucked out. For example, the self-priming vacuum pump 130 operates at a range of 3 to 12 V. FIG. 3C illustrates yet another embodiment of a suction inducing device 130A attached to the outlet 120 of the tray insert 100. According to the embodiment, the suction inducing device 130A is a syringe with one-way valve. In an embodiment, when the tray insert 100 is extended out of apparatus for inspection/analysis, the syringe 130A creates a suction to pull the accumulated liquid from the hollow enclosure through the outlet 120. The one-way valve of the syringe 103A ensures that liquid from the hollow enclosure does not flow back into the tray insert 100.

In an alternative embodiment, the outlet 120 may be positioned on the first opposing end 103 of the tray insert 100. Therefore, the suction inducing device 130, 130A may be positioned towards the first opposing end 103 of the tray insert 100. In a further embodiment, the suction inducing device 130, 130A may be connected to a container prefilled with polymer beads. For example, the polymer beads may be disinfectant entrapped hydrogel beads which are sensitive to liquid. Therefore, the hydrogel beads may swell up when brought in contact with the liquid sample. The polymer beads have three-dimensional networks and porous structure, thereby making them highly hydrophilic. The polymer beads may also include a pH indicator along with the disinfectant. When the container fills up with the liquid sample, the polymer beads swell and cause diffusion of trapped disinfectant along with the pH indicator. The pH of the liquid sample may cause a change in color of the polymer beads. This acts as an indicator for a user to replace the contaminated container with a new container.

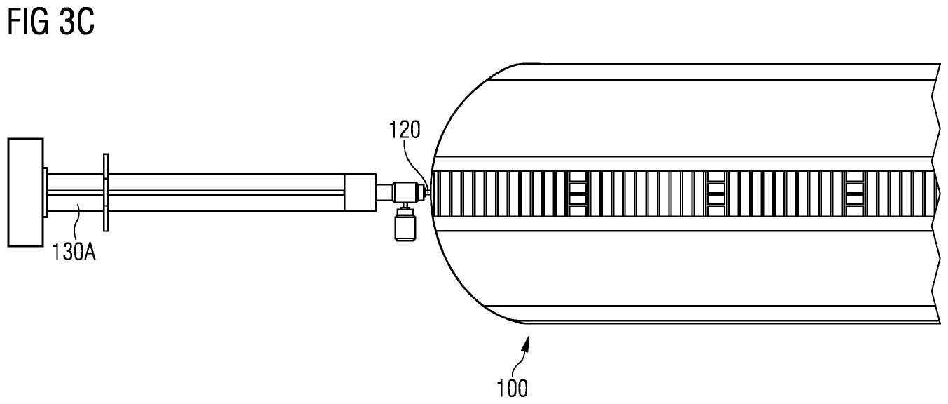

FIG. 4 illustrates a perspective view of the tray insert 100 being positioned in a support tray 400 of an apparatus, according to an embodiment of the invention. The support tray 400 includes a first and second opposing ends 401, 402, a top surface 403 extending between the first and the second opposing ends 401, 402 and having a compartment 404 extending from the first opposing end 401 for receiving the tray insert 100. The compartment 404 includes an end wall 410 conforming to the second opposing end 104 of the tray insert 100. Further, the compartment 404 includes opposing first and second side walls 420, 421 extending from the end wall 410 and conforming to the first opposing side 105 and the second opposing side 106 of the tray insert 100. The top surface 403 of the support tray 400 includes an elongated channel 430 extending from the second opposing end 402 of the support tray 400, and a white calibration strip (not shown) is received in the elongated channel 430. The top surface 403 of the support tray 400 also includes a sloped surface 431 extending from a center of the end wall 410 of the compartment 404. The first surface 101 and the second surface of the tray insert 100 include valleys and depressions 164 that correspond to the sloped surface 431 of the support tray 400, when the tray insert 100 is positioned within the compartment 404.

The compartment 404 may include cut-outs 440 for allowing the first and the second opposing sides 105, 106 of the tray insert 100 to be grasped when the tray insert 100 is positioned within the compartment 404. The support tray 400 also includes elongated guides 441 that correspond to the elongated guides 160 of the tray insert 100 when the tray insert 100 is positioned in the compartment 404. Further, the compartment 404 includes stops 450 for engaging the tray insert 100 when the tray insert 100 is positioned within the compartment 404. The stops 450 prevent the tray insert 100 from sliding out of the compartment 404. In an embodiment, the stops 450 are positioned such that they engage with the first opposing end 103 of the tray insert 100 when the tray insert 100 is positioned inside the compartment 404. The support tray 400 also includes a land 460 having a lip 461. The support tray 400 also includes a notch 462 which may be used as an exit port for the suction inducing device 130, 130A. In an embodiment, the support tray 400 may be a part of a tray assembly 480 of the apparatus.

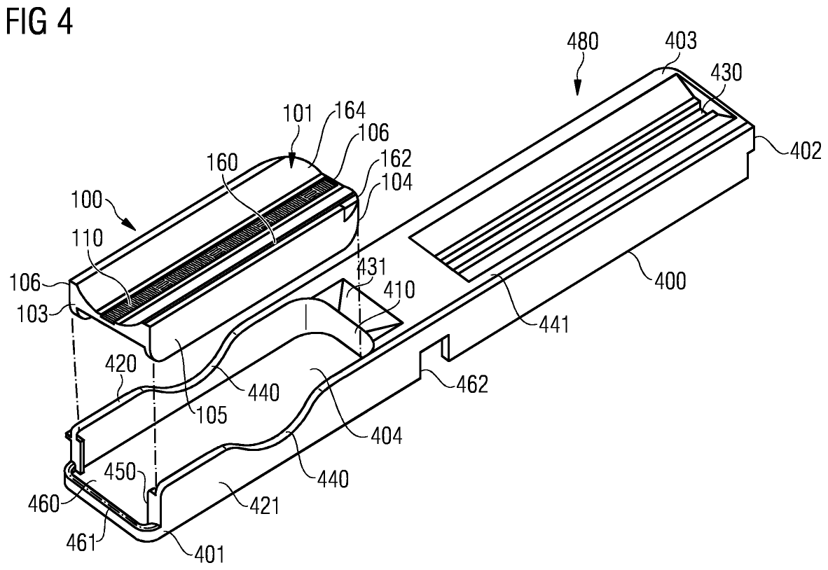

FIG. 5 illustrates a perspective view of the tray insert 100 wherein the second surface 102 of the tray insert is facing upwardly, according to an embodiment of the invention. The second surface 102 of the tray insert 100 has a recess 140 shaped to receive a reagent cassette. An end wall 141 of the recess 140 of the second surface 102 of the tray insert 100 is curved to match a curved end wall of the reagent cassette, to ensure that a user correctly orients the reagent cassette within the tray insert 100. The tray insert 100 includes bosses 142A and 142B at an open end 143 of the recess 140. The bosses 142A and 142B are received in indents of the reagent cassette to prevent the reagent cassette from sliding out of the tray inset 100. Alternatively, the tray insert 100 may include indents and the reagent cassette may include bosses.

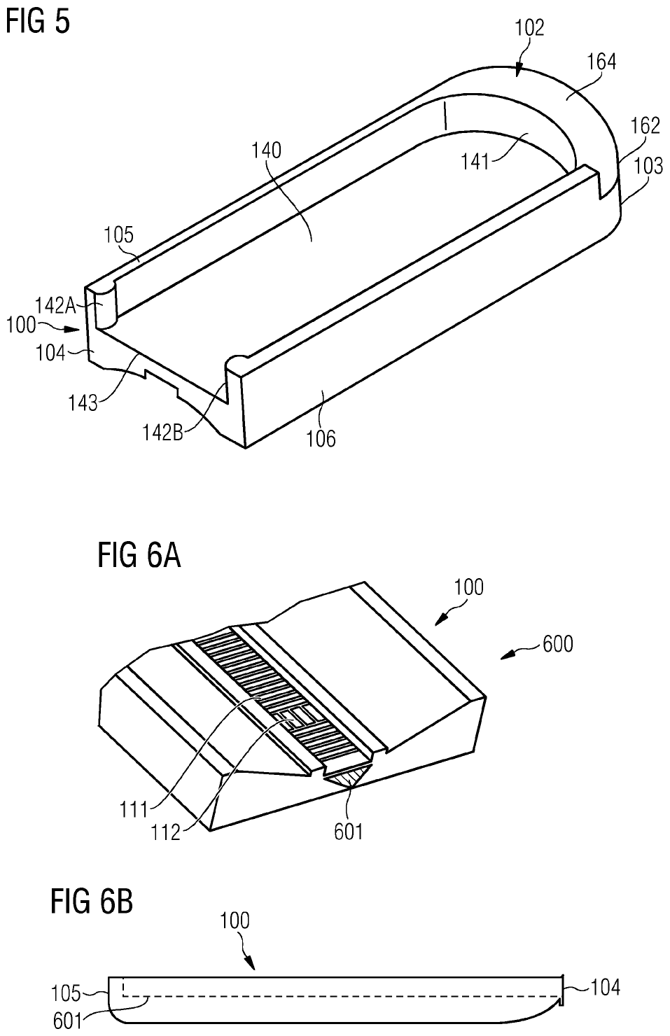

FIG. 6A is a cross-sectional view 600 of the tray insert 100, depicting the hollow enclosure 601, according to an embodiment. In the embodiment 600, the hollow enclosure 601 is triangular such that a vertex of the triangle forms a base of the hollow enclosure 601. The base of the elongated channel 110 forms a top edge of the hollow enclosure 601. Any liquid accumulated in the elongated channel 110 of the tray insert 100 trickles into the hollow enclosure 601 through the openings 113 on the ends of the horizontal slots 111 on the elongated channel 110. In an alternate embodiment, the hollow enclosure 601 may be cuboid in shape. FIG. 6B illustrates a side view of the hollow enclosure 601. The hollow enclosure 601 extends to the outlet 120 positioned on the second opposing end 104 of the tray insert 100.

### Non-Limiting Illustrative Embodiments

The following is a number list of non-limiting illustrative embodiments of the inventive concept disclosed herein:
Illustrative embodiment 1. A tray insert for use with an apparatus configured to analyze a sample, the tray insert comprising: a first surface comprising an elongated channel adapted to receive a reagent strip for sample analysis; a second surface, wherein the second surface is in a direction opposite to the first surface; a hollow enclosure between the first surface and the second surface; wherein the elongated channel on the first surface comprises a plurality of slots, wherein the slots comprise an opening on each end, wherein the opening enters the hollow enclosure.
Illustrative embodiment 2. The tray insert of illustrative embodiment 1, wherein the first surface and the second surface of the tray insert further comprise: a first opposing end and a second opposing end connecting the first and the second surfaces; and a first opposing side and a second opposing side connecting the first surface and the second surface and extending between the first opposing end and the second opposing end, wherein the first surface, the second surface, the first opposing end and the second opposing end, the first opposing side and the second opposing side enclose the hollow enclosure.
Illustrative embodiment 3. The tray insert of illustrative embodiments 1-2, wherein the plurality of slots on the elongated channel comprises a combination of vertical slots and horizontal slots.
Illustrative embodiment 4. The tray insert of any one of the preceding illustrative embodiments, wherein only the horizontal slots have openings on each end.
Illustrative embodiment 5. The tray insert of any one of the preceding illustrative embodiments, wherein the vertical slots connect to one of the horizontal slots on each end of the vertical slots.
Illustrative embodiment 6. The tray insert of any one of the preceding illustrative embodiments, wherein the second surface is adapted to receive a reagent cassette.
Illustrative embodiment 7. The tray insert of any one of the preceding illustrative embodiments, wherein the first surface of the tray insert has an end wall closing the elongated channel, wherein the end wall is a vertical extension of the second opposing end connecting the first surface and the second surface.
Illustrative embodiment 8. The tray insert of any one of the preceding illustrative embodiments, wherein the hollow enclosure has an opening on the second opposing end.
Illustrative embodiment 9. The tray insert of any one of the preceding illustrative embodiments, wherein the hollow enclosure has an opening on the first opposing end.
Illustrative embodiment 10. The tray insert of any one of the preceding illustrative embodiments, wherein the opening of the hollow enclosure is configured to be attachable to a suction inducing device.
Illustrative embodiment 11. The tray insert of any one of the preceding illustrative embodiments, wherein the suction inducing device is a vacuum pump.
Illustrative embodiment 12. The tray insert of any one of the preceding illustrative embodiments, wherein the suction inducing device is a syringe with a one way valve.
Illustrative embodiment 13. The tray insert of any one of the preceding illustrative embodiments, wherein a shape of the first opposing end is rectangular and a shape of the second opposing end is curved.
Illustrative embodiment 14. The tray insert of any one of the preceding illustrative embodiments, wherein the tray insert is configured to be insertable in a support tray of the apparatus configured to analyze a sample.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A tray insert for use with an apparatus configured to analyze a sample, the tray insert comprising:
a first surface comprising an elongated channel adapted to receive a reagent strip for sample analysis;
a second surface, wherein the second surface is in a direction opposite to the first surface;
a hollow enclosure between the first surface and the second surface;
wherein the elongated channel on the first surface comprises a plurality of slots,
wherein the slots comprise an opening on each end, wherein the opening enters the hollow enclosure.

2. The tray insert of claim 1, wherein the first surface and the second surface of the tray insert further comprise:
a first opposing end and a second opposing end connecting the first and the second surfaces; and
a first opposing side and a second opposing side connecting the first surface and the second surface and extending between the first opposing end and the second opposing end, wherein the first surface, the second surface, the first opposing end and the second opposing end, the first opposing side and the second opposing side enclose the hollow enclosure.

3. The tray insert of claim 1, wherein the plurality of slots on the elongated channel comprises a combination of vertical slots and horizontal slots.

4. The tray insert of claim 3, wherein only the horizontal slots have openings on each end.

5. The tray insert of claim 3, wherein the vertical slots connect to one of the horizontal slots on each end of the vertical slots.

6. The tray insert of claim 1, wherein the second surface is adapted to receive a reagent cassette.

7. The tray insert of claim 1, wherein the first surface of the tray insert has an end wall closing the elongated channel, wherein the end wall is a vertical extension of the second opposing end connecting the first surface and the second surface.

8. The tray insert of claim 1, wherein the hollow enclosure has an opening on the second opposing end.

9. The tray insert of claim 1, wherein the hollow enclosure has an opening on the first opposing end.

10. The tray insert of claim 8, wherein the opening of the hollow enclosure is configured to be attachable to a suction inducing device.

11. The tray insert of claim 10, wherein the suction inducing device is a vacuum pump.

12. The tray insert of claim 10, wherein the suction inducing device is a syringe with a one way valve.

13. The tray insert of claim 2, wherein a shape of the first opposing end is rectangular and a shape of the second opposing end is curved.

14. The tray insert of claim 1, wherein the tray insert is configured to be insertable in a support tray of the apparatus configured to analyze a sample.
